(19) United States
(12) Patent Application Publication
(10) Pub. No.: US 2014/0193726 A1
(43) Pub. Date: Jul. 10, 2014

(54) FULL CELL SYSTEM AND METHOD OF HUMIDIFYING AND COOLING THE SAME

(71) Applicants: Yong Gyu Noh, Suwon (KR); Hyuck Roul Kwon, Yongin (KR); Hyo Sub Shim, Suwon (KR)

(72) Inventors: Yong Gyu Noh, Suwon (KR); Hyuck Roul Kwon, Yongin (KR); Hyo Sub Shim, Suwon (KR)

(73) Assignee: HYUNDAI MOTOR COMPANY, Seoul (KR)

(21) Appl. No.: 14/102,585

(22) Filed: Dec. 11, 2013

(30) Foreign Application Priority Data
Dec. 31, 2012 (KR) 10-20120158605

(51) Int. Cl. H01M 8/04

(52) U.S. Cl. CPC H01M 8/04141; H01M 8/04067
USPC 429/414

(57) ABSTRACT

A method of humidifying and cooling a fuel cell system is provided. The method of humidifying and cooling a fuel cell system includes: exhausting, by a fuel supply unit, a hydrogen gas to a reservoir in which condensed water of an anode is stored. Additionally, a hydrogen gas and condensed water are pumped and the hydrogen gas and the condensed water are exhausted to the humidifier. Additionally, compressed air of an air compressor is delivered to the humidifier heat is exchanged with compressed air in the humidifier. The hydrogen gas and compressed air in which a heat is exchanged in a humidified state is delivered to an anode and a cathode, respectively.

### CROSS-REFERENCE TO RELATED APPLICATION

This application claims priority to and the benefit of Korean Patent Application No. 10-2012-0158605 filed in the Korean Intellectual Property Office on Dec. 31, 2012, the entire contents of which are incorporated herein by reference.

### BACKGROUND OF THE INVENTION

(a) Field of the Invention

The present invention relates to a fuel cell system and a method of humidifying and cooling the same that efficiently humidify a fuel cell and cools compressed air using condensed water of the anode.

(b) Description of the Related Art

Typically, as shown in FIG. 1, a fuel cell system 102 includes a stack 110 that generates electrical energy through an electrochemical reaction, a fuel supply unit 120 that supplies a hydrogen gas, which is fuel to the stack 110, an air supply unit 130 that supplies air necessary for the electrochemical reaction to the stack 110, and a heat/water management unit 140 that removes a reaction heat of the stack 110 to outside of the system and that controls an operation temperature of the stack 110 and performs a water management operation.

The fuel supply unit 120 of the fuel cell system 102 includes a hydrogen tank 122 and an ejector 126, the air supply unit 130 includes an air compressor 132, an intercooler 134, and a humidifier 136, and the heat and water management unit 140 includes a coolant pump 142, a coolant reservoir 144, and a radiator 146.

A hydrogen gas of a high pressure that is supplied from the hydrogen tank 122 of the fuel supply unit 120 is supplied to the stack 110 with a lower pressure via the ejector 126. The stack 110 of the fuel cell system 102 is formed in an electrical generator set in which a plurality of unit cells are continuously arranged, and each unit cell is provided as a fuel cell of a unit that generates electrical energy via an electrochemical reaction of hydrogen and air.

The unit cells include as membrane-electrode assembly and separators that are each disposed to close contact at both sides thereof. In this case, the separators are formed in a plate form having conductivity and each form a channel for flowing fuel and air to a close contact surface of the membrane-electrode assembly.

The membrane-electrode assembly may be formed in a structure that forms an anode on one surface and forms a cathode on the other one surface and that forms an electrolyte membrane between the anode and the cathode.

The anode separates fuel that is supplied through the channel of the separator into electrons and protons through an oxidation reaction, and the electrolyte membrane performs a function of moving protons to a cathode. The cathode generates water and a heat through a reduction reaction of electrons and protons that receive from the anode and oxygen of air that is received through the channel of the separator.

A portion of water that is generated at the cathode by a chemical reaction moves toward the anode by permeating the electrolyte membrane, and when water flows through the anode remains in a catalyst layer, the amount reaction of the catalyst is reduced, and when water that is moved to the anode stays at the channel, the water blocks a hydrogen supply path.

Therefore, water that flows through the anode is exhausted to a reservoir 150 through an exhaust line 152, and when water is collected, the reservoir 150 opens a drain valve 154 and exhausts water accordingly.

Furthermore, it is essential to raise an air pressure for mass production of the fuel cell system 102, and in order to raise an air pressure, the fuel cell system 102 should operate with high power. When the fuel cell system 102 operates at high power, the air pressure rises and the relative humidity and an oxygen concentration of air that is supplied to the stack 110 raised as well. Additionally, an outlet temperature of the air compressor 132 rises to about 120° C. and thus it is disadvantageous to operate the humidifier 136 and the stack 110 at this time. Therefore, in order to appropriately lower an air temperature, it is necessary to install an additional intercooler 134 between the humidifier 136 and the air compressor 132.

However, because the intercooler 134 is typically volumetrically large, it is disadvantageous to apply the intercooler 134 to a package. The intercooler 134 also increases pressure damage within the air compressor 132, and a coolant flow channel is additionally required. As a result, the equipment required to perform these functions is complicated.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a fuel cell system having advantages of cooling compressed air in which a temperature has risen under high power operation while efficiently humidifying an anode using condensed water of the anode and omitting the need for a separate intercooler and parts for exhausting condensed water of the anode.

An exemplary embodiment of the present invention provides a fuel cell system including: a stack that has an anode and a cathode; a fuel supply unit that supplies a hydrogen gas of a hydrogen tank to the anode through a hydrogen supply line; an air supply unit that supplies compressed air of an air compressor to the cathode via a humidifier through an air supply line; and a reservoir that exhausts condensed water of the anode. The fuel supply unit connects the hydrogen supply line to the anode via the reservoir and the humidifier, the hydrogen gas and the compression air are exhausted to the reservoir via, e.g., pumping, and the injected hydrogen gas and condensed water exchange a heat with compressed air in the humidifier.

At the anode, an unreacted hydrogen gas may be injected into the reservoir through a recirculation line. The reservoir may house a pumping unit that is connected to the hydrogen supply line, and the pumping unit may be configured to pump a hydrogen gas, condensed water, and an unreacted hydrogen gas within the reservoir. The pumping unit may include an ejector, a venturi tube, and a jet pump, and a pumping tube that pumps condensed water that is pooled at the bottom within the reservoir may be connected to the pumping unit.

The humidifier may form a fuel path (i.e., a hydrogen flow channel) in an opposite direction with respect to a flow of dry air at the humidifier, a heat transfer pin may be mounted on a wall surface of the hydrogen flow channel to form a heat exchanger, and a hydrogen gas including a supersaturation vapor that is exhausted from the reservoir may exchange a heat while passing through the fuel path.

At the upper stream side of the humidifier, a fuel path may be formed in a vertical direction to the flow of dry air, a heat transfer pin may be mounted on a wall surface of the fuel path to form a heat exchanger, and a hydrogen gas including a supersaturation vapor that is exhausted from the reservoir may exchange a heat with dry air while passing through the fuel path.

Alternatively, at the lower stream side of the humidifier, a fuel path may he formed in a vertical direction to the flow of dry air, a heat transfer pin may be mounted at a wall surface of the fuel path to form a heat exchanger, and a hydrogen gas including a supersaturation vapor that is exhausted from the reservoir may exchange a heat while passing through the fuel path.

The humidifier may form the fuel path in a vertical direction to the flow of humid air at an inlet into which humid air is injected, and a heat transfer pin may be mounted at a wall surface of the fuel path to form a heat exchanger, and a hydrogen gas including a supersaturation vapor that is exhausted from the reservoir may exchange a heat with humid air while passing through the fuel path.

Another embodiment of the present invention provides a method of humidifying and cooling a fuel cell system, the method including: exhausting, by a fuel supply unit, a hydrogen gas of a hydrogen tank to a reservoir in which condensed water of an anode is stored; pumping, by a reservoir, a hydrogen gas and condensed water and exhausting the hydrogen gas and the condensed water to the humidifier; delivering, by an air supply unit, compressed air of an air compressor to the humidifier; exchanging, by the injected hydrogen gas and condensed water, a heat with compressed air in the humidifier; and delivering, by the humidifier, the hydrogen gas and compressed air in which a heat is exchanged in a humidified state to an anode and a cathode, respectively.

More specifically, hydrogen gas that is unreacted at the anode may be injected into the reservoir. The reservoir may pump a hydrogen gas, condensed water, and a hydrogen gas that is unreacted at the anode and exhaust the hydrogen gas, the condensed water, and the hydrogen gas in a form of a hydrogen gas including a supersaturation vapor, and a hydrogen supply line may deliver the hydrogen gas including a supersaturation vapor to the humidifier. The humidifier may house a heat exchanger through which the hydrogen gas including a supersaturation vapor passes.

The heat exchanger may be formed at the center of a hollow fiber membrane module of the humidifier, and a hydrogen gas including a supersaturation vapor may exchange heat while flowing in a backward direction to flow of dry air. Furthermore, the heat exchanger may be formed on the upper stream side of the humidifier, and the hydrogen gas including a supersaturation vapor may exchange heat with dry air that is injected into the humidifier while flowing in a vertical direction to the flow of dry air.

Likewise, the heat exchanger may be formed on the downstream side of the humidifier, and the hydrogen gas including a supersaturation vapor may exchange a heat while flowing in a vertical direction to the flow of dry air. In some embodiments, the heat exchanger may be formed in an inlet into which humid air is injected, the hydrogen gas including a supersaturation vapor may be formed in a vertical direction to flow of humid air, and the hydrogen gas including a supersaturation vapor may exchange a heat with the humid air.

According to an exemplary embodiment of the present invention, condensed water of an anode is sent to a humidifier instead of being exhausted, and the humidifier can humidify an anode by evaporating condensed water using the heat of compressed air that is raised under a high power operating conditions.

Further, compressed air in which a temperature has risen under a high power operating conditions can be cooled by exchanging a heat with hydrogen including supersaturation vapor that is injected into the humidifier without having to install a separate intercooler.

Additionally, by forming a reservoir and an ejector in a module and by forming a humidifier and a heat exchanger in a module, parts for exhausting condensed water of an anode and a separate intercooler can he omitted, and as such, the size of the entire package can he minimized.

### BRIEF DESCRIPTION OF THE DRAWINGS

FIG. 1 is a schematic diagram of a conventional fuel cell system.

FIG. 2 is a schematic diagram of a fuel cell system according to an exemplary embodiment of the present invention.

FIG. 3 is a schematic diagram of a reservoir according to exemplary embodiments of the present invention.

FIGS. 4 and 5 are side cross-sectional views of a humidifier according to exemplary embodiments of the present invention.

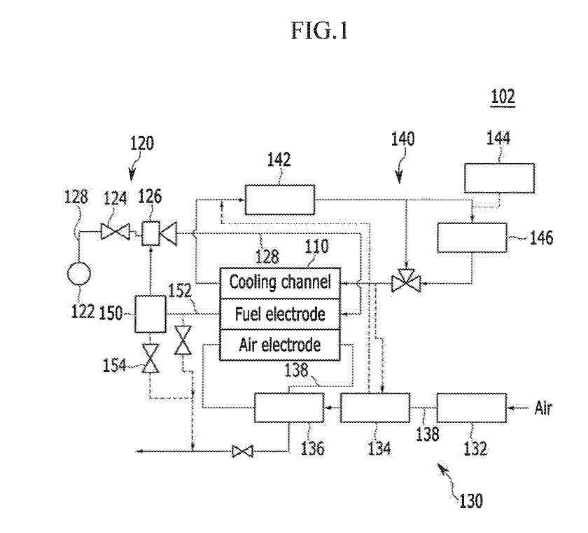

### DETAILED DESCRIPTION OF THE EMBODIMENTS

The present invention will be described more fully hereinafter with reference to the accompanying drawings.

Although exemplary embodiments of the present invention have been shown and described, it will be apparent to those having ordinary skill in the art that a number of changes, modifications, or alterations to the invention as described herein may be made, none of which depart from the spirit of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid fuel cell vehicles, electric fuel cell vehicles, plug-in hybrid fuel cell vehicles, a hydrogen-powered fuel cell vehicles, etc. As referred to herein, a hybrid vehicle is a vehicle that has two or more sources of power, for example both gasoline-powered and electric-powered vehicles.

The terminology used herein is for the purpose of describing particular embodiments only and is not intended to he limiting of the invention. As used herein, the singular forms “a”, “an” and “the” are intended to include the plural forms as well, unless the context clearly indicates otherwise, it will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

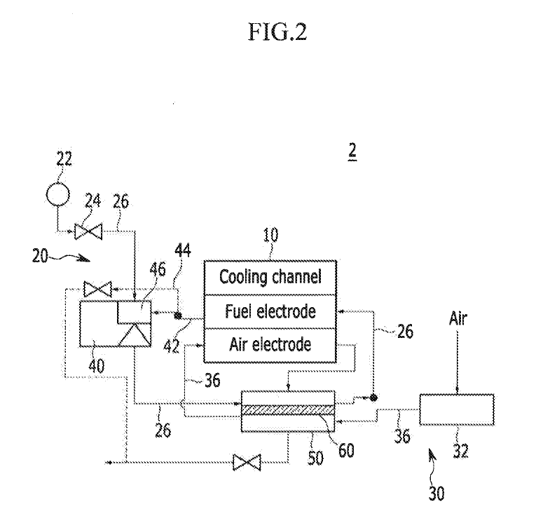

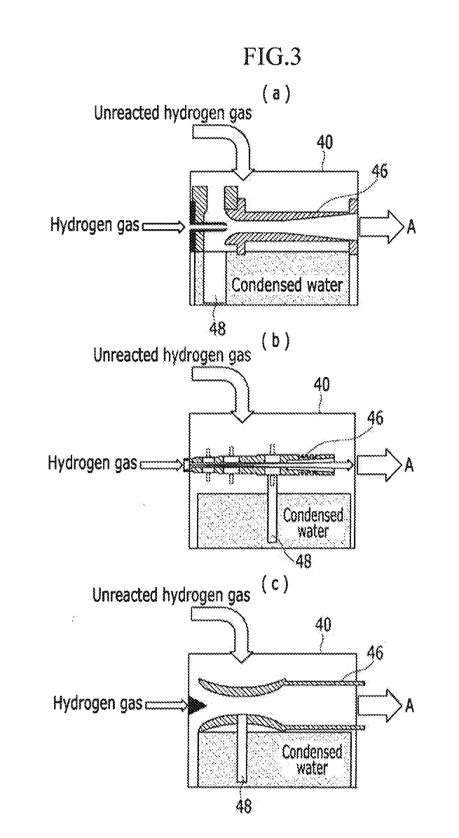

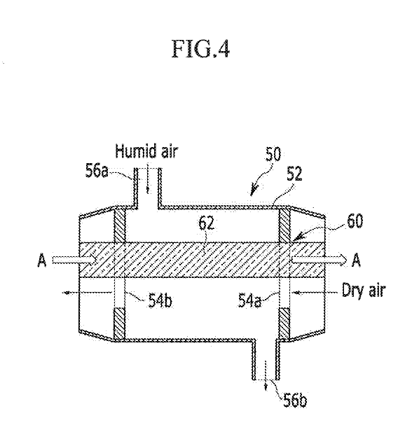

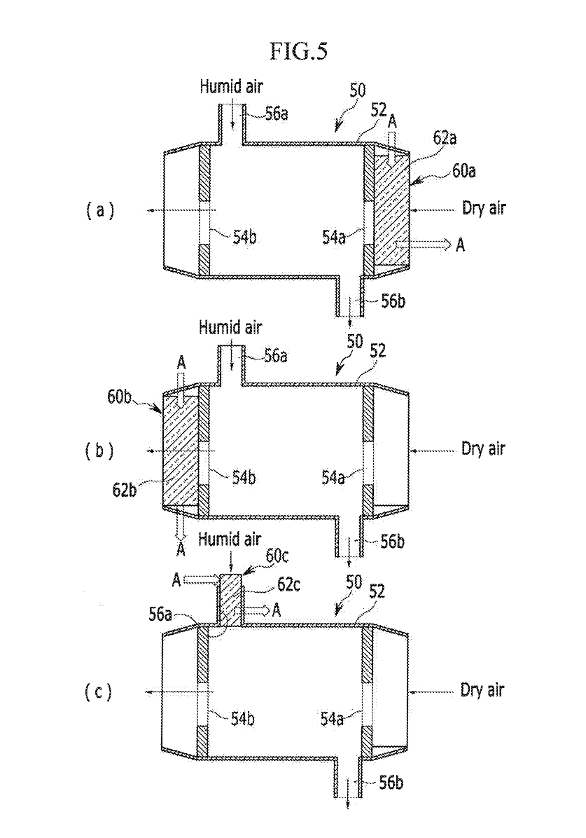

FIG. 2 is a schematic diagram of a fuel cell system according to an exemplary embodiment of the present invention, FIG. 3 is a schematic diagram of a reservoir according to exemplary embodiments of the present invention, and FIGS. 4 and 5 are side cross-sectional views of a humidifier according to exemplary embodiments of the present invention.

A fuel cell system 2 according to an exemplary embodiment of the present invention includes a stack 10 that is formed as a set of unit cells, a fuel supply unit 20 that supplies a hydrogen gas to the stack 10, an air supply unit 30 that supplies air to the stack 10, and a reservoir 40 that exhausts condensed water of the anode.

The stack 10 of the fuel cell system 2 is formed as a electrical generator set in which a plurality of unit cells are continuously arranged, and each unit cell is provided as a fuel cell of a unit that generates electrical energy by an electrochemical reaction of hydrogen and air. The unit cells include a membrane-electrode assembly and separators that are disposed to close contact at both sides thereof.

In this case, the separators are formed in a plate form having conductivity and each form channels for flowing fuel and air with a close contact surface of the membrane-electrode assembly. The membrane-electrode assembly is formed in a structure that forms an anode on one surface and a cathode on the other one surface and that forms an electrolyte membrane between the anode and the cathode. The anode separates hydrogen that is supplied through a channel of the separator into electrons and protons through an oxidation reaction, and the electrolyte membrane moves protons toward a cathode. The cathode generates water and heat through a reduction reaction of electrons and protons that are received from the anode side and oxygen of air that is received through the channel of the separator.

The fuel supply unit 20 of the fuel cell system 2 includes a hydrogen tank 22 and a pressure adjustment valve 24, and the air supply unit 30 includes an air compressor 32 and a humidifier 50. A reservoir 40 that exhausts generated condensed water and unreacted hydrogen gas and a purge line 44 that exhausts impurities within the anode are further connected to the anode.

In an exemplary embodiment of the present invention, condensed water and an unreacted hydrogen gas that are exhausted from the anode and hydrogen gas of the fuel supply unit 20 are collected to the reservoir 40 and are delivered to the humidifier 50, and compressed air of the air supply unit 30 is delivered to the humidifier 50. The condensed water and the hydrogen gas exchange heat with compressed air within the humidifier 50 to be cooled and humidified and are then supplied to the anode and the cathode.

The fuel supply unit 20 is formed so that a hydrogen supply line 26 is connected to the hydrogen tank 22, the reservoir 40, the humidifier 50, and the anode, and the air supply unit 30 is formed so that an air supply line 36 is connected to the air compressor 32, the humidifier 50, and the cathode. In particular, the hydrogen gas of a high pressure is stored at the hydrogen tank 22 of the fuel supply unit 20.

In the hydrogen supply line 26 between the hydrogen tank 22 and the reservoir 40, the pressure adjustment valve 24 that decompresses a hydrogen gas of a high pressure that is supplied from the hydrogen tank 22 is installed. The pressure adjustment valve 24 may be formed as a valve that adjusts a pressure of a fluid like a pressure regulator and a flux adjustment valve. A hydrogen gas that is adjusted into an appropriate pressure via the pressure adjustment valve 24 is injected into the reservoir 40.

Further, unreacted hydrogen gas and condensed water that is generated at the anode are injected into the reservoir 40 through a recirculation line 42. The reservoir 40 may be embodied as a storing tank for storing the fluids. The fluids are stored at the reservoir 40 and are re-injected continuously into the humidifier 50 through the hydrogen supply line 26. In this case, in order to efficiently pump a hydrogen gas, condensed water, and unreacted hydrogen gas that are injected into the reservoir 40 and sent to the humidifier 50, the reservoir 40 has a pumping unit 46 for pumping the gases accordingly.

The pumping unit 46 may be embodied as an ejector, a venturi tube, and a jet pump. When the pumping unit 46 is formed in an ejector, the pumping unit 46 may be formed in a single ejector and a multistage ejector, as shown in FIGS. 3A and 3B. A pumping tube 48 that pumps condensed water that is stored within the reservoir 40 is connected to the pumping unit 46 to be disposed to move downward to the bottom side within the reservoir 40. The pumping unit 46 pumps hydrogen gas that is received from the hydrogen tank 22 and unreacted hydrogen gas and condensed water that is generated in the anode and exhausts them to the hydrogen supply line 26 that is connected to the humidifier 50.

A hydrogen gas, condensed water, and an unreacted hydrogen gas are injected into the humidifier 50 through the hydrogen supply line 26 in a form of a hydrogen gas A that includes a supersaturation vapor. The humidifier 50 may be a film humidifier in which a hollow fiber membrane module that is formed with a plurality of hollow fiber membranes that are condensed within a housing 52 is disposed.

At both side surfaces of the housing 52, an inlet 54a and an outlet 54b through which dry air passes are formed, and an inlet 56a and an outlet 56b through which humid air passes are formed on one side and the other side of an exterior circumference of the housing 52. Dry air which passes through the air compressor 32 of the air supply unit 30 is injected into the inlet 54a and passes through the inside of a hollow membrane module.

Humid air that is exhausted through a cathode of the stack 10 is supplied into the inlet 56a to move outside of the hollow membrane module, and moisture of humid air is separated by a capillary operation of the hollow fiber membrane, and the separated moisture is condensed while permeating a capillary tube of the hollow fiber membrane to move to the inside of the hollow fiber membrane, and dry air that is injected into the inlet 54a by such moisture is humidified and exhausted to the outlet 54b.

When the fuel cell system 2 is operated at high power, the air pressure rises and a relative humidity and an oxygen concentration of air that is supplied to the stack 10 rise, but an outlet temperature of the air compressor 32 rises and thus a high temperature of dry air is injected into the humidifier 50 through the air supply line 36.

In the humidifier 50, a high temperature of dry air that is injected through the air supply line 36, a hydrogen gas A including a supersaturation vapor that is injected through the hydrogen supply line 26, and humid air that is exhausted through the cathode exist. Three kinds of gases exchange a heat while forming different flow channels within the humidifier 50.

In the humidifier 50, in order to efficiently exchange a heat, a heat exchanger 60 is further formed, and a hydrogen gas A including a supersaturation vapor that is injected through the hydrogen supply line 26 passes through the heat exchanger 60. As shown in FIG. 4, in the heat exchanger 60, a fuel path 62 that may pass through a hydrogen gas A including a supersaturation vapor is formed at the center of a hollow fiber membrane module, and a heat transfer pin (not shown) may be mounted on a wall surface of the fuel path 62.

The fuel path 62 that is formed in the heat exchanger 60 is formed in a backward direction to flow of dry air that is injected through the air supply line 36 to further efficiently perform a heat exchange.

Further, a heat transfer pin (not shown) may be made of a metal material having high thermal conductivity.

In the humidifier 50, a high temperature of dry air and humid air and a hydrogen gas A including a supersaturation vapor exchange a heat while flowing in a different direction. That is, high temperature dry air and a hydrogen gas A including a supersaturation vapor flow in opposite directions while passing though the center of the hollow fiber membrane module of the humidifier 50, and humid air exchanges a heat while flowing to the outside of the hollow membrane module.

Further, the hydrogen gas A including a supersaturation vapor receives a heat of a high temperature of dry air while passing through the heat exchanger 60 to become a hydrogen gas of a high dew point, and a high temperature of dry air loses a heat and a temperature thereof is lowered, and humid air that is injected into the cathode is condensed well and to further improve a humidifying effect of dry air.

As an exemplary variation, as shown in FIG. 5A, a heat exchanger 60a may form a fuel path 62a in a vertical direction to flow of dry air at the upper stream side of the humidifier 50 into which dry air injected. In this case, an only heat exchange between a high temperature of dry air and a hydrogen gas A including a supersaturation vapor is performed, and when the high temperature of dry air is supplied to the humidifier, while a liquid droplet that is included in the hydrogen gas evaporates, much heat is taken from dry air and thus an air temperature may be more efficiently lowered.

Further, as an exemplary variation, as shown in FIG. 5B, a heat exchanger 60b may form a fuel path 62b in a vertical direction to the flow of dry air at the downstream side of the humidifier SO into which dry air is injected. When it is difficult to form a package of a system of FIG. 5A, the heat exchanger 60b of FIG. 5B may he selected. Further, as an exemplary variation, as shown in FIG. 5C, a heat exchanger 60c may form a fuel path 62c in a vertical direction to the flow of humid air at the inlet 56a into which humid air is injected.

The heat exchanger 60c of FIG. 5C uses a heat exchange method of a hydrogen gas A including humid air and a supersaturation vapor. A high temperature of humid air that is exhausted from the cathode is cooled, and hydrogen gas A including a supersaturation vapor may further raise a dew point of a hydrogen gas by absorbing a heat of humid air.

The above method further improves a humidifying performance of dry air upon operating the fuel cell system 2 with high power. As shown in FIGS. 4 and 5, a hydrogen gas in which a heat is exchanged in the humidifier is injected into the anode through a hydrogen supply line in a humidified state, and a high temperature of air is injected into the cathode through the air supply line in a state in which a temperature is lowered.

By the above configuration, a fuel cell system according to exemplary embodiments of the present invention can cool compressed air in which a temperature has risen under high power operation while smoothly humidifying an anode without having to install a separate intercooler and parts for exhausting condensed water of the anode.

While this invention has been described in connection with what is presently considered to be practical exemplary embodiments, it is to be understood that the invention is not limited to the disclosed embodiments, hut, on the contrary, is intended to cover various modifications and equivalent arrangements included within the spirit and scope of the appended claims.

### DESCRIPTION OF SYMBOLS

2: fuel cell system

10: stack

20: fuel supply unit

26: hydrogen supply line

30: air supply unit

32: air compressor

36: air supply line

40: reservoir

42: recirculation line

46: pumping unit

48: pumping tube

50: humidifier

60,60a,60b,60c: heat exchanger

What is claimed is:

1. A fuel cell system, comprising:
a stack including an anode and a cathode;
a fuel supply unit that supplies a hydrogen gas of a hydrogen tank to the anode through a hydrogen supply line;
an air supply unit that supplies compressed air of an air compressor to the cathode via a humidifier through an air supply line; and
a reservoir that exhausts condensed water of the anode,
wherein the fuel supply unit connects the hydrogen supply line to the anode via the reservoir and the humidifier, the hydrogen gas and the compression air exhausted to the reservoir and the injected hydrogen gas and condensed water exchange a heat with compressed air in the humidifier.

2. The fuel cell system of claim 1, wherein:
an unreacted hydrogen gas at the anode is injected into the reservoir through a recirculation line;
the reservoir is provided with a pumping unit that is connected to the hydrogen supply line; and
the pumping unit pumps a hydrogen gas, condensed water, and an unreacted hydrogen gas within the reservoir.

3. The fuel cell system of claim 1, wherein the pumping unit comprises an ejector, a venturi tube, and a jet pump, and
a pumping tube pumps condensed water that is pooled at the bottom within the reservoir is connected to the pumping unit.

4. The fuel cell system of claim 1, wherein the humidifier forms a fuel path in an opposite direction with respect to a flow of dry air at the humidifier, a heat transfer pin is mounted within a wall surface of the fuel path to form a heat exchanger, and a hydrogen gas comprising a supersaturation vapor that is exhausted from the reservoir exchanges a heat while passing through the fuel path.

5. The fuel cell system of claim 1, wherein at the upper stream side of the humidifier, a fuel path is formed in a vertical direction to a flow of dry air, a heat transfer pin is mounted within a wall surface of the fuel path to form a heat exchanger, and a hydrogen gas comprising a supersaturation vapor that is exhausted from the reservoir exchanges a heat with dry air while passing through the fuel path.

6. The fuel cell system of claim 1, wherein at the lower stream side of the humidifier, a fuel path is formed in a vertical direction to a flow of dry air, a heat transfer pin is mounted within a wall surface of the fuel path to form a heat exchanger, and a hydrogen gas comprising a supersaturation vapor that is exhausted from the reservoir exchanges a heat while passing through the fuel path.

7. The fuel cell system of claim 1, wherein the humidifier forms the fuel path in a vertical direction to a flow of humid air at an inlet into which humid air is injected, and a heat transfer pin is mounted within a wall surface of the fuel path to form a heat exchanger, and a hydrogen gas comprising a supersaturation vapor that is exhausted from the reservoir exchanges a heat with humid air while passing through the fuel path.

8. A method of humidifying and cooling a fuel cell system, the method comprising:
exhausting, by a fuel supply unit, a hydrogen gas to a reservoir in which condensed water of an anode is stored;
pumping, by a reservoir, a hydrogen gas and condensed water and exhausting the hydrogen gas and the condensed water to the humidifier;
delivering, by an air supply unit, compressed air of an air compressor to the humidifier;
exchanging, by the injected hydrogen gas and condensed water, a heat with compressed air in the humidifier; and
delivering, by the humidifier, the hydrogen gas and compressed air in which a heat is exchanged in a humidified state to an anode and a cathode, respectively.

9. The method of claim 8, wherein a hydrogen gas that is unreacted at the anode is injected into the reservoir.

10. The method of claim 9, wherein the reservoir pumps a hydrogen gas, condensed water, and a hydrogen gas that is unreacted at the anode and exhausts the hydrogen gas, the condensed water, and the hydrogen gas in a form of a hydrogen gas comprising a supersaturation vapor, and a hydrogen supply line delivers the hydrogen gas comprising a supersaturation vapor to the humidifier.

11. The method of claim 10, wherein the humidifier houses a heat exchanger through which the hydrogen gas comprising a supersaturation vapor passes.

12. The method of claim 11, wherein the heat exchanger is formed at the center of a hollow fiber membrane module of the humidifier, and the hydrogen gas comprising a supersaturation vapor exchanges a heat while flowing in a backward direction to flow of dry air.

13. The method of claim 11, wherein the heat exchanger is formed at the upper stream side of the humidifier, and the hydrogen gas comprising a supersaturation vapor exchanges a heat with dry air that is injected into the humidifier while flowing in a vertical direction to flow of dry air.

14. The method of claim 11, wherein the heat exchanger is formed at the downstream side of the humidifier, and the hydrogen gas comprising a supersaturation vapor exchanges a heat while flowing in a vertical direction to flow of dry air.

15. The method of claim 11, wherein the heat exchanger is formed in an inlet into which humid air is injected, the hydrogen gas comprising a supersaturation vapor is formed in a vertical direction to flow of humid air, and the hydrogen gas comprising a supersaturation vapor exchanges a heat with the humid air.
